(19) United States
(12) Patent Application Publication
(10) Pub. No.: US 2011/0254291 A1
(43) Pub. Date: Oct. 20, 2011

(54) EXTERIOR DOOR HANDLE, PARTICULARLY FOR VEHICLES, AND METHOD FOR THE PRODUCTION THEREOF

(76) Inventors: Michael Rhein, Monchengladbach (DE); Bernd Gerdes, Essen (DE); Simone Van Thiel, Krefeld (DE); Wolfgang Lipinski, Velbert (DE); Jörg Weidner, Wuppertal (DE); Michael Geber, Aichwald (DE); Uwe Freyholdt, Giengen/Brenz (DE)

(21) Appl. No.: 12/998,976

(22) PCT Filed: Dec. 14, 2009
(86) PCT No.: PCT/EP2009/009100

§ 371 Date: Jun. 20, 2011

(30) Foreign Application Priority Data
Dec. 20, 2008 (DE) 10 2008 064 339.4

(51) Int. Cl. E05B 65/20; B23P 17/00; E05B 1/00

(52) U.S. Cl. 292/336.3; 29/428

(57) ABSTRACT

The invention relates to an exterior door handle, particularly for vehicles, and to a method for the production thereof. The exterior handle comprises a movable handle in the form of an at least regionally hollow housing, in which electronic components (31) can be accommodated. Furthermore, a printed circuit board (30) is provided, which is used to accommodate at least some of the electronic components (31). Furthermore, a Hall element (20), which is to be arranged in a predefined location in the handle, is provided in the handle. According to the invention, the printed circuit board (30) is constructed in a rigid and flat manner and a separate holder (10) is provided. Said holder (10) carries the Hall element (20) and holds it in the predefined position thereof in the interior of the handle. The position is spaced from the printed circuit board (30).

The invention relates to an exterior door handle, in particular for vehicles according to the features of the preamble of claim 1 as well as a method for the production of the exterior door handle according to claim 14. Such exterior door handles are employed frequently in modern vehicles. Electronic device components can be provided in the interior of the handle, which electronic device components for example control the access authorization to the vehicle or also perform other functions and tasks. The electronic device components are here disposed on the printed circuit board in most cases.

Since the various vehicle types exhibit also different handles for the exterior door handles, the electronic device components or, respectively, the printed circuit board have to be adapted to the shape of the handle. If a Hall sensor is furnished at the electronics of the handle, for example for detecting a motion of the handle relative to the vehicle, relative to the vehicle door or relative to the grip bearing, then the Hall sensor has to be applied at a certain predefined position. In most cases, the Hall sensor comprises here two parts, namely the sensor proper and a permanent magnet. For purposes of simplicity both shall be designated as “Hall element”. In order to furnish now corresponding exterior door handles for the most different vehicle types, the printed circuit board, on which the electronic device components are located, has to be individually adapted for each exterior door handle. This is very expensive and intensive with respect to costs and storage area. Since the exterior door handles are frequently produced of bent shape for sensible and aesthetic reasons, as a rule also a bent printed circuit board has to be provided in order to place the corresponding Hall element in the corresponding position. The device components are in this case mounted on a foil, which in turn is placed on a support device component. This support device component is then adapted with respect to its form to the form of the corresponding exterior door handle. This production process is clearly more expensive and complicated as to the production of conventional printed circuit boards.

Therefore it is an object of the invention to furnish an exterior door handle, which can be produced in a simple way and with favorable costs, as well as in addition to prepare a method by way of which exterior door handles in most different shapes with the same electronic components can be simple and cost favorable be produced. This object is resolved by the characterizing features of claim 1 as well as by claim 14, which claims have the following special importance.

The printed circuit board is formed rigid and planar. Furthermore, a separate holder is furnished, which holder supports the Hall element and thereby holds the Hall element in the interior of the handle at the desired predefined position. This position is at a distance from the printed circuit board. It is thereby possible to furnish a rigid and planar printed circuit board also even at bent handles. Nevertheless, the Hall element can be applied at the desired predefined position based on the separate holder.

According to claim 14 identical printed circuit boards can be furnished for different types of the exterior door handles and thereby also different types of handles. By the adaptation of the employed holder, the Hall element can be disposed quasi any desired position. This saves production and storage costs, in particular for the printed circuit boards and only different holders have to be stored for different applications.

It is particularly advantageous to preassemble the Hall element with the holder and form thereby a device group. This device group can then be more simply mounted, in particular at the printed circuit board or also directly in the handle.

It occurs frequently that the Hall element comprises electrical conductors. It is here then particularly advantageous if the holder exhibits guides for this or, respectively, these electrical conductor (s). A correct positioning of the conductors and a protection against damages are herewith enabled.

Further embodiments and advantages of the invention result from the sub claims, from the following description and from the drawings. The invention is presented in various embodiment examples in the figures. There is shown in:

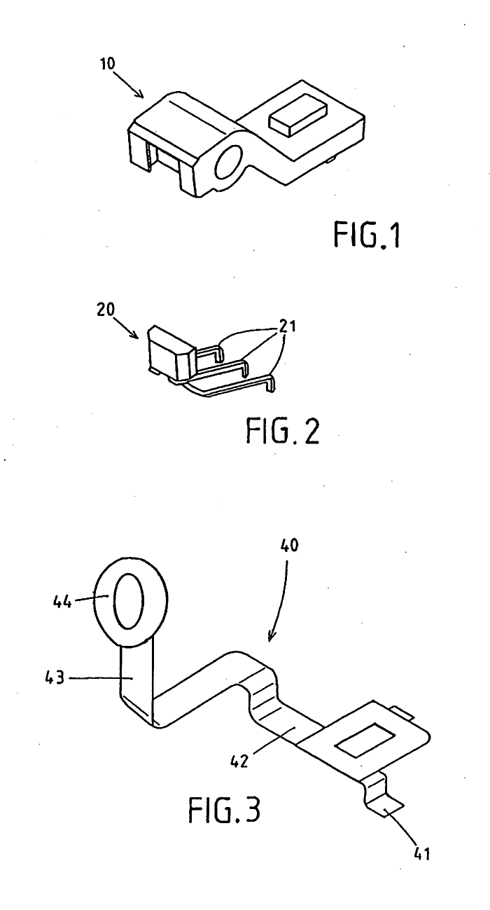

FIG. 1 a holder according to the invention in a first embodiment;

FIG. 2 a Hall element according to the invention in a first embodiment;

FIG. 3 a potential balancing element according to the invention in a first embodiment;

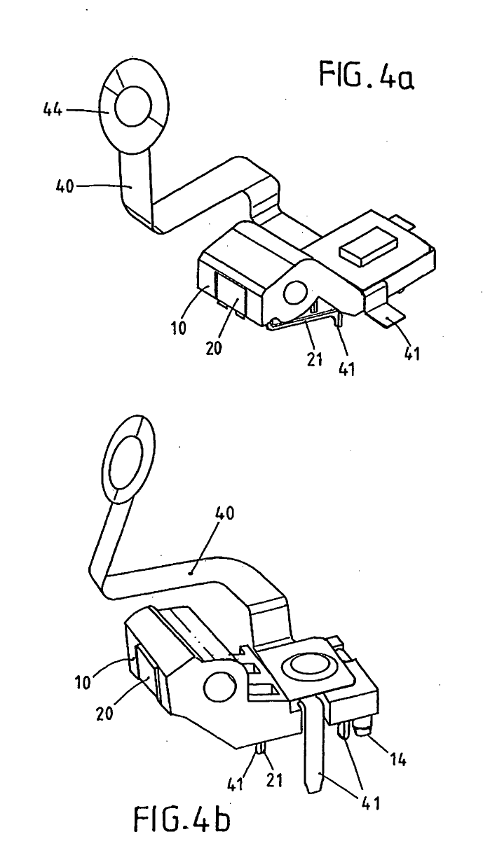

FIG. 4a the assembly of the elements of FIGS. 1, 2, and 3;

FIG. 4b a holder, a Hall element, and a potential balancing element assemblied in a second embodiment;

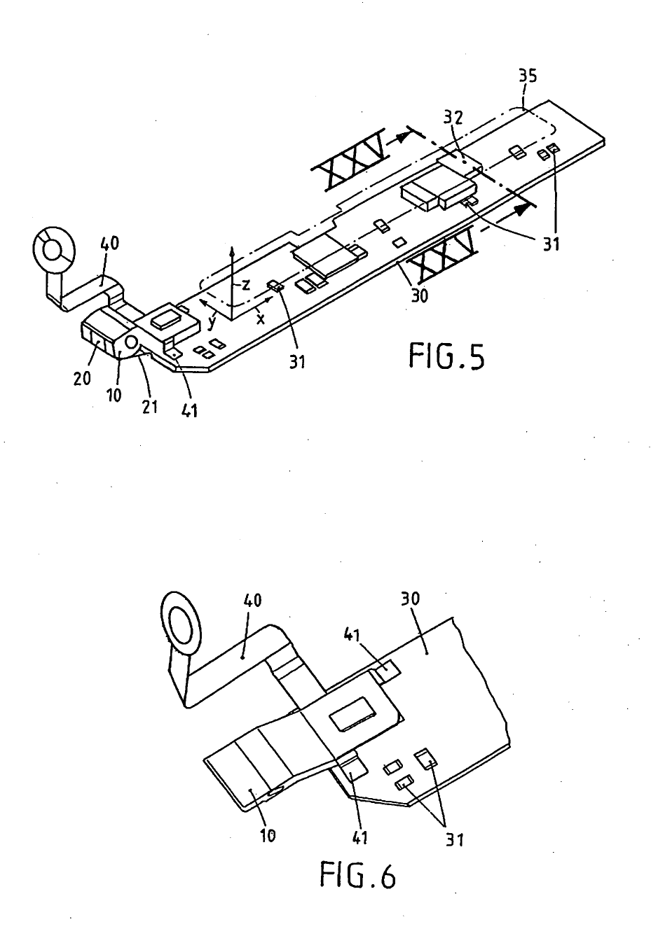

FIG. 5 the elements of the FIG. 4a in assembly with a printed circuit board and with a wedge;

FIG. 6 a detailed view of FIG. 5;

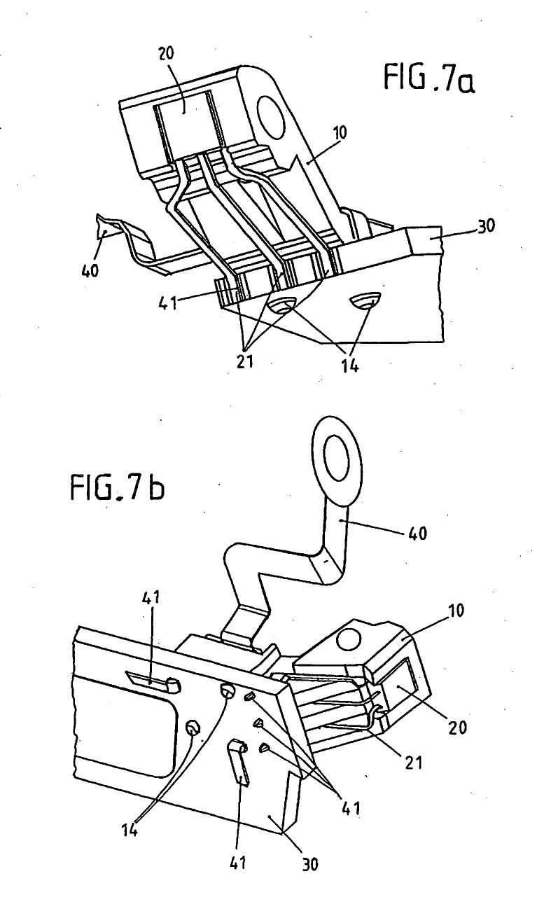

FIG. 7a the elements of FIG. 6 in a perspective view from below;

FIG. 7b the elements of FIG. 4b on a printed circuit board, in a perspective view from below;

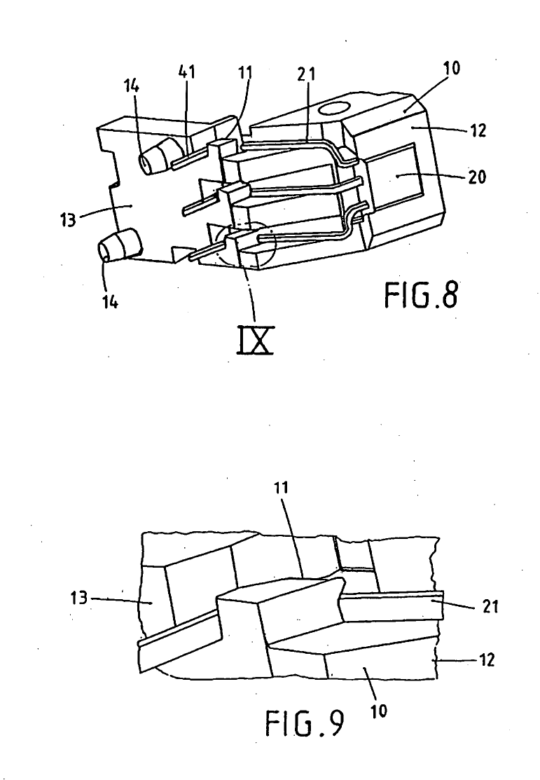

FIG. 8 a Hall element with a two parts holder;

FIG. 9 an enlarged section from FIG. 8;

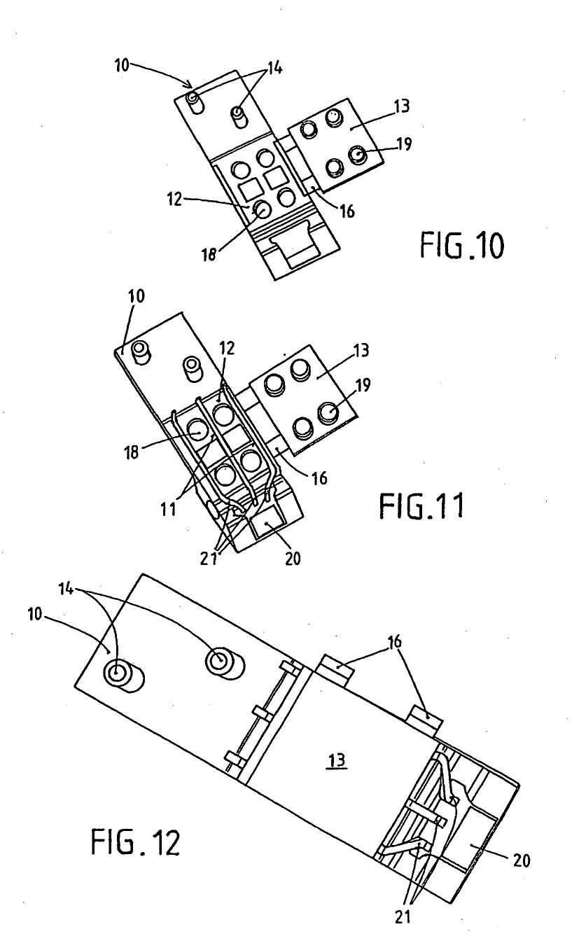

FIG. 10 a further embodiment example of a holder according to the invention;

FIG. 11 the holder from FIG. 10 with incorporated Hall element prior to final assembly;

FIG. 12 holder and Hall element from the FIGS. 10 and 11 in an assembled state;

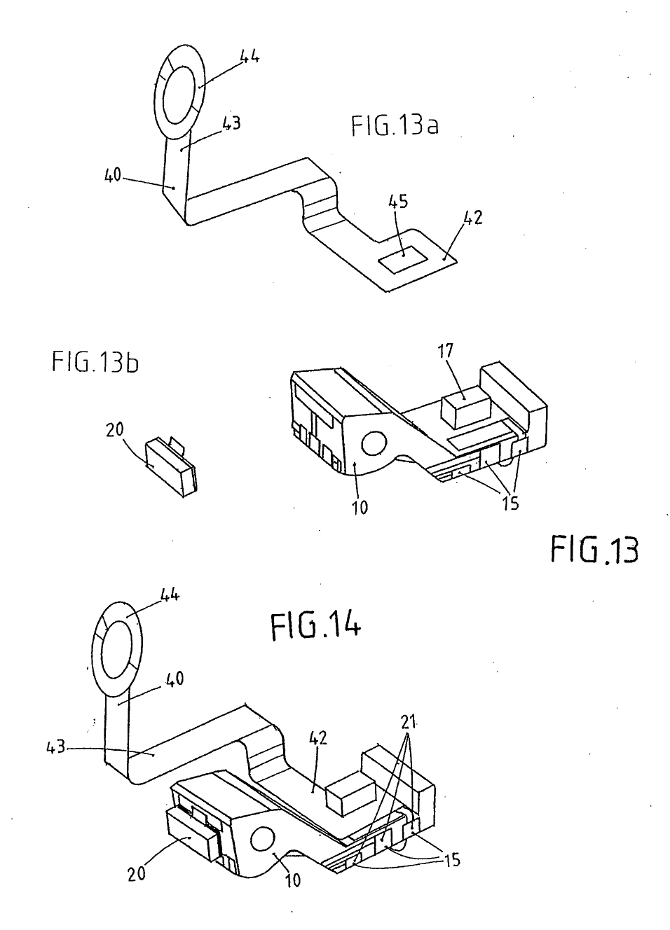

FIG. 13 a further embodiment example of a holder with a Hall element and a potential balancing element in an exploded view;

FIG. 14 the elements of FIG. 13 in an assembled state;

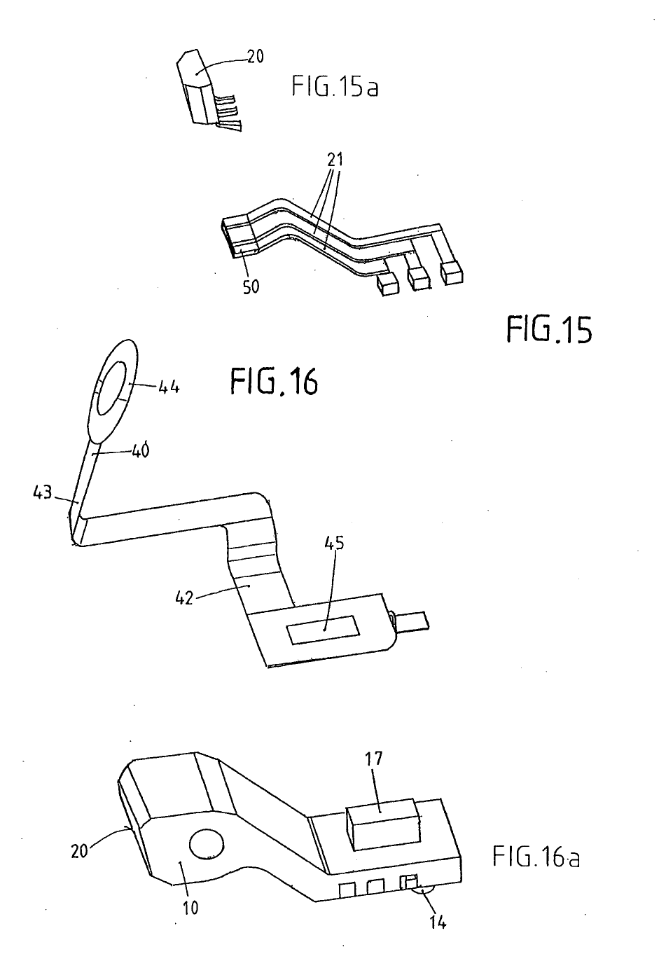

FIG. 15 a Hall element with electrical conductors as a stamped grate frame in an exploded view;

FIG. 16 the elements from FIG. 15 including a holder;

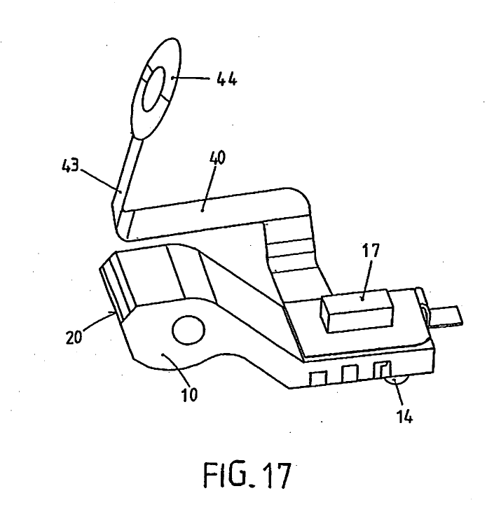

FIG. 17 the device group of FIG. 16 with applied potential balancing element;

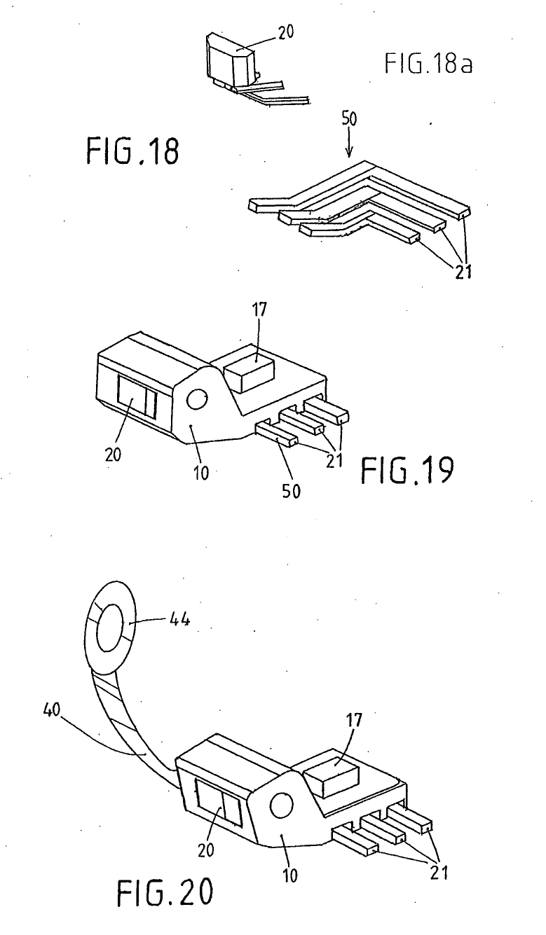

FIG. 18 a further embodiment example of the elements from FIG. 15;

FIG. 19 embodiment example from FIG. 18 in a representation according to FIG. 16;

FIG. 20 device group from FIG. 19 with mounted potential balancing element;

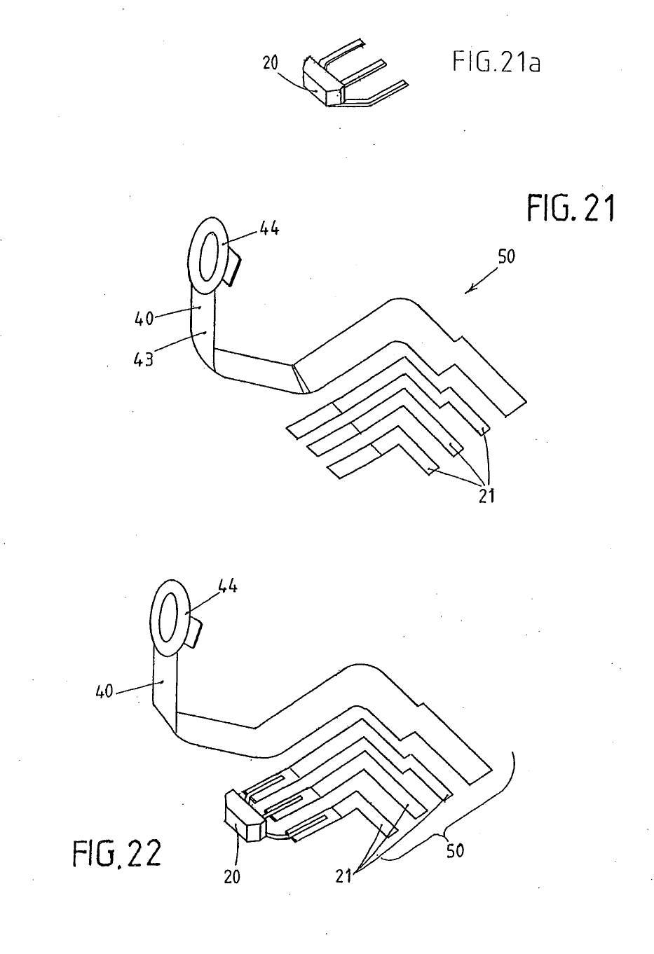

FIG. 21 a last embodiment of the invention with pressed screen and Hall element in an exploded view;

FIG. 22 the elements from FIG. 21 with mounted Hall element;

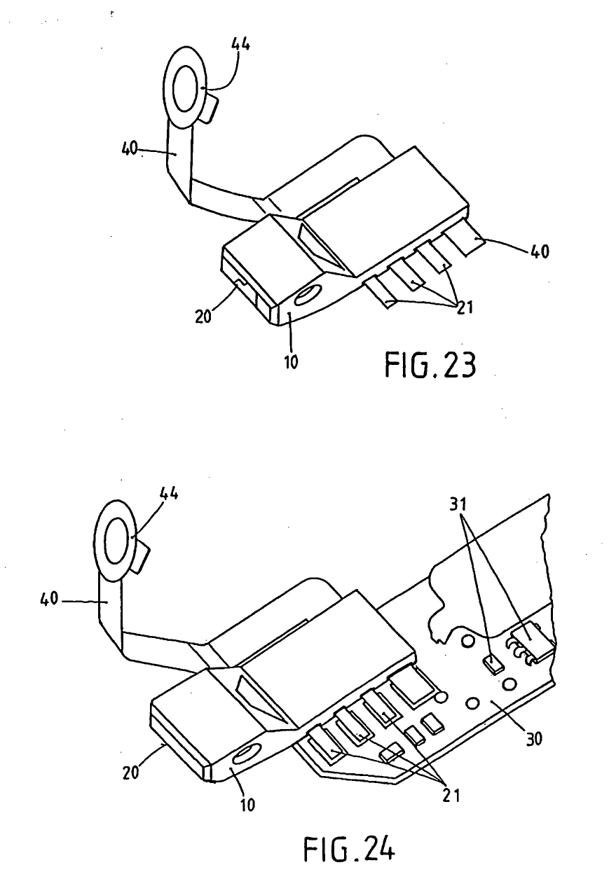

FIG. 23 the elements of FIG. 22 with injection molded holder;

FIG. 24 the elements from FIG. 23 mounted to the printed circuit board;

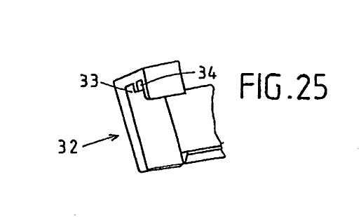

FIG. 25 wedge from FIG. 5.

FIG. 1 shows a holder 10 according to the invention for the Hall element 20 from FIG. 2. The Hall element 20 comprises here the proper Hall sensor. Of course it is also possible to furnish a permanent magnet as a Hall element, while the sensor is located in another region of the vehicle, for example in the vehicle goal or in the exterior door handle. The Hall element 20 has here electrical conductors 21.

A potential balancing element 40 is also furnished in this embodiment example. The potential balancing element 40 serves for potential balancing in a metallic, metal covered and/or otherwise electrically conducting housing element of the handle. The potential balancing element 40 comprises in the present embodiment example a sheet metal and has an eyelet 44 at its one end 43 remote relative to the holder 10, wherein the potential balancing element can be brought with the corresponding housing part of the handle through the eyelet 44 in electrical operating connection. For this purpose mostly rivet or screw connections are offered.

The potential balancing element 40 has prefixing means 41 at its other end 42 disposed towards the holder 10, wherein the closer importance will be explained further down. The potential balancing element 40 has further connection means 45 at its other end 42, which connection means 45 can be brought in operating connection with counter connection means 17 of the holder 10, in order to mount the potential balancing element 40 at the holder 10.

FIG. 4a now shows a device group comprising the holder 10, the Hall element 20, the electrical conductors 21 and the potential balancing element 40 from the FIGS. 1 through 3. The Hall element 20 and the potential balancing element 40 are disengageably connected to the holder 10 and in fact by jamming or, respectively, by making a clip connection. Of course also other connection possibilities are conceivable, such as for example clamping, plugging, hooking up behind or also non disengageable connection possibilities such as adhesively attaching, welding, injection molding, or casting. In principle, all connection possibilities are conceivable.

FIG. 5 shows now the device group from FIG. 4a applied to a printed circuit board 30. The printed circuit board 30 can here use different electronic device parts 31. The holder 10 is in operating connection with the conductor plate 30, wherein here again in each case the most different connection possibilities are conceivable. Here, the connection can be performed disengageable or also non disengageable. The Hall element 20 is disposed at a distance from the printed circuit board 30, in order to be brought at its required position. A coordinate system is presented in FIG. 5 for purposes of illustration. The Hall element has to be positioned at a predefined point depending on the application case. This point deviates in the coordinate system in x-, y-, and/or z-direction from the position of the printed circuit board 30. This distance is overcome by the holder 10 according to the present invention, wherein the holder 10 operates as a connection piece between the Hall element 20 and the printed circuit board 30.

Furthermore, the potential balancing element 40 is in operating connection with the printed circuit board 30 through the holder 10. It is particularly advantageous to connect the potential balancing element 40 with the ground potential of the printed circuit board 30 in order to enable the potential balancing of the electrically conducting housing device part of the handle.

In addition, one recognizes the prefixing means 41 of the potential balancing element 40, which prefixing means take care of that the potential balancing element 40 is contacted at the right locations with the printed circuit board 30. Basically also the holder 10 takes care of this, wherein the holder 10 is disposed at its predetermined position at the printed circuit board 30.

FIG. 5 shows additionally also the wedge 32, which can be recognized in more detail from FIG. 25. The wedge 32 performs here several tasks. The wedge is employed in particular where the exterior door handle comprises an about U-shaped base shell. The base shell is frequently furnished with comparatively thin walls in order to save weight and material costs. This as well as the possibly present production tolerances can lead to the situation that the arms of the U stand too closely together at their upper end of the arms of the U such that they cannot any longer be brought in operating connection for example with a provided cover shell. The wedge 32 spreads in an incorporated state the two U-arms of the base shell, such that the ends of the two U-arms maintain the predefined distance. In addition the wedge 32 has still the task to properly position the printed circuit board 30 in the door handle. For this purpose the wedge 32 is furnished with a first receiver 33 for the printed circuit board 30. If in addition to the printed circuit board 30 there is also an electrode 35 furnished, which is here indicated by dash-dotted lines in FIG. 5, then the wedge 32 can exhibit a second receiver 34 for the electrode 35. A secure and correct incorporation of the printed circuit board 30 in the door handle is furnished through the positioning of the printed circuit board 30 with the aid of the wedge 32.

If the electrode 35 is positioned in the door handle by way of the second receiver 34 of the wedge 32, then thereby further advantages result. In particular, upon employing of a capacitive electrode 35 it is thereby assured that the capacitive electrode 35 is placed always at the same correct position in the door handle. Otherwise different positions of the electrode 35 could be generated by production and incorporation tolerances, which would also lead to different electromagnetic properties of the electrode 35 and thus a stable sensing or, respectively, release behavior of the electronics would not any longer be present.

It is particularly advantageous to make a clip connection between the wedge 32 and the printed circuit board 30 and/or the electrode 35. This represents a simple and cost favorable way of assembly. Then the wedge 32 including the printed circuit board 30 or, respectively, the electrode 35 is introduced into the base shell of the door handle. Usually then a casting mass is entered into the door handle, for example a casting resin or a silicon mass, in order to protect the vehicle electronics from soiling and humidity. Finally, an upper gripping shell or a cover can be placed into the handle.

The FIGS. 6 and 7 show again clearly how the device group consisting of holder 10, Hall element 20, and potential balancing element 40 from the FIGS. 1 through 3 are disposed at the printed circuit board 30. One recognizes here also the positioning means 14 of the holder 10, as well as the prefixing means 41 of the electrical conductors 21 of the Hall element 20 and of the potential balancing element 40. These positioning means 14 and prefixing means 41 serve to place the device group particularly simple and quick at the printed circuit board 30. Of course it is also possible to furnish the positioning means 14 and the prefixing means 41 as a single device component. The electrical conductors 21 of the Hall element 20 and the potential balancing element 40 are positioned on the printed circuit board 30, in particular by the disposition of the holder 10 at the printed circuit board 30. The holder 10 is clipped at the printed circuit board 30 by way of the positioning means 14. Of course also other methods of disengageable or non disengageable connections are conceivable between the printed circuit board 30 and the holder 10, the Hall element 20, or the electrical conductors 21 of the Hall element 20 or also the potential balancing element 40. The electrical conductors 21 of the Hall element 20 and/or the potential balancing element 40 or, respectively, the prefixing means 41 can then still be soldered to the printed circuit board 30 in order to generate a secure electrical connection.

The FIGS. 4b and 7b show a device group according to the FIGS. 4a and 7a, however in a different embodiment example. Here again the holder 10, the Hall element 20 and the potential balancing element 40 are initially assembled as a device group and are then mounted at the printed circuit board 30. The holder 10 has here again available the positioning means 14, while the electrical conductors 21 of the Hall element 20 and the potential balancing element 40 have available prefixing means 41.

A particularly advantageous embodiment example is shown in FIGS. 8 and 9. Here the holder 10 is formed from two parts. The first part 12 serves for receiving the Hall element 20. The electrical conductors 21 of the Hall element 20 are led through the guides 11 of the second part 13 of the holder during the mounting of the second part 13 at the first part 12. This way a secure mounting of the electrical conductors 21 is obtained during the mounting of the holder 10 at the printed circuit board 30 and a damaging of the electrical conductors 21 of the Hall element 20 are avoided.

The FIGS. 10 through 12 show a further embodiment example of the invention device. The holder 10 is here formed of two parts 12, 13. The two parts 12, 13 are connected to each other through two film hinges 16. Furthermore, the parts 12, 13 exhibit recesses 18 and projections 19 through which the parts 12, 13 are connectable to each other by way of a snap-in or, respectively, plug connection. The associated electrical conductors 21 are positioned immediately in the first part 12 of the holder 10 during the mounting of the Hall element 20. The second part 13 of the holder 10 is flipped like a cover over the first part 12 of the holder 10 and is plugged together with the first part 12. Here the projections 19 and the recess 18 are brought into operating connection. The device group shown in FIG. 12 is generated therefrom. One recognizes the positioning means 14 at the holder 10, which serve for positioning the device group at the printed circuit board 30. Of course the two parts 12, 13 of the holder 10 can be connected to each other, disengageable or non disengageable, also in a different kind. All kinds of attachment or, respectively, connection are here conceivable in principle.

A further embodiment example is shown in FIGS. 13 and 14. The electrical conductors 21 of the Hall element 20 are here realized directly at the holder 10. This occurs in the present embodiment example by conducting regions 15 of the holder 10, wherein the conducting regions are predominantly formed by conducting plastic. Of course it is also conceivable to integrate the electrical conductors 21 in the holder 10, for example by injection molding of metallic conductor paths. Also the electrical contacting of the potential balancing element 40 is performed through conducting regions 15 integrated over the holders 10.

The potential balancing element 40 is, as already also shown in several of the preceding embodiment examples, connected through a connection means 45 to a counter connection means 17 at the holder 10. The connection means 45 is here disposed at the other end 42 of the potential balancing element 40. In the present case, a plug connection is present between the connection means 45 and the counter connection means 17. Of course, here again other disengageable and non disengageable connections are conceivable such as for example adhesively attaching, welding, making a clip connection, snap-in connection or the like.

Again three further embodiments of the invention are shown in the FIGS. 15 through 17, 18 through 20, and 21 through 24. The presence of a punched grate frame 50, which can exhibit different embodiments and which comprises the electrical conductors 21 of the respective Hall element 20 as well as possibly also the potential balancing element 40 as shown in FIGS. 21 through 24.

A simple as possible and cost favorable production of a device group comprising a Hall element 20 with electrical conductors 21, holder 10 and potential balancing element 40 results therefrom. Preferably initially the Hall element 20 is welded to the punched grate frame 50. Then the device parts, with or without potential balancing element 40 depending on the embodiment, are injected by injection molding with plastic in order to form the holder 10 in this manner. This finished device group can then be placed on the printed circuit board 30 as shown in FIG. 24. It is also possible to injection mold directly positioning means 14 at the holder 10 in order to further simplify the contacting with the printed circuit board 30.

Finally it is pointed out that the embodiments shown here represent only the realization of the invention by way of example. The invention is not limited thereto. Instead different changes and modifications are possible. The features shown in the description of the figures can of course also be realized in another combination. Also the stamped grate frame can assume the most different forms and dimensions. The holder itself also does not require the forms shown in the figures, but it is formed individually depending on the special application case.

### LIST OF REFERENCE CHARACTERS

10 holder
11 guide for 21
12 first part of 10
13 2nd part of 10
14 positioning means
15 conducting region at 10
16 film hinge
17 counter connection means
18 recess
19 projection
20 Hall element
21 electrical conductor of 20
30 printed circuit board
31 electronic device component
32 wedge
33 first receiver at 32
34 2nd receiver at 32
35 electrode
40 potential balancing element
41 prefixing means
42 other end of 40
43 one end of 40
44 eyelet
45 connection means
50 punched grate frame

1. Exterior door handle, in particular for vehicles, having a movable handle shaped as a housing, which is at least in regions hollow, wherein electronic device components (31) are receivable in the hollow housing, wherein a printed circuit board (30) is furnished, which at least in part serves for receiving the electronic device components (31), wherein furthermore a Hall element (20) is furnished in the handle,
characterized in that
the printed circuit board (30) is formed rigid and planar,
wherein a separate holder (10) is furnished, which supports the Hall element (20) and which holds the Hall element (20) in the interior of the handle at its predefined position, and
wherein this position is at a distance from the printed circuit board (30) and
wherein this distance is overcome by the holder (10), which operates as connection piece between the Hall element (20) and the printed circuit board (30).

2. Exterior door handle according to claim 1,
characterized in that
a potential balancing element (40) is furnished for potential balancing of a metallic and/or metal covered and/or otherwise electrically conducting housing element of the handle, wherein preferably an eyelet (44) is furnished at the one end (43) of the potential balancing element (40).

3. Exterior door handle according to claim 2,
characterized in that
the potential balancing element (40) can be disposed at the holder (10), in particular through connection means (45) furnished at the other end (42) of the holder (10), wherein the connection means (45) is connectable with a counter connection means (17), wherein the connection means (45) and the counter connection means (17) can be brought together into operating connection, and preferably through the holder (10) with the printed circuit board (30), in particular to the ground potential of the printed circuit board (30).

4. Exterior door handle according to claim 1,
characterized in that the Hall element (20) and/or the potential balancing element (40) are premountable at the holder (10) and form a device group with the holder (10).

5. Exterior door handle according to claim 1,
characterized in that
the Hall element (20) exhibits one or several electrical conductors (21), which are formed in particular by conducting regions (15) of the holder (10), in particular from conducting plastic.

6. Exterior door handle according to claim 1,
characterized in that
the holder (10) exhibits guides (11) for the electrical conductors (21) of the Hall element (20) and/or for the potential balancing element (40).

7. Exterior door handle according to claim 5,
characterized in that
the electrical conductors (21) of the Hall element (20) and/or the potential balancing element (40) are preformed from a stamped grate frame (50), wherein the Hall element (20) is connected to and in particular welded to the stamped grate frame (50).

8. Exterior door handle according to claim 1,
characterized in that
the holder (10) is formed from two parts.

9. Exterior door handle according to claim 8,
characterized in that
the first part (12) of the holder (10) serves for receiving the Hall element (20) and/or the potential balancing element (40) and wherein the electrical conductors (21) of the Hall element (20) and/or the potential balancing element (40) are guided (11) and/or preformed by the first (12) and/or the second part (13),
wherein the two parts (12, 13) of the holder (10) are connectable to each other, in particular by plugging, making a clip connection, a snap-in connection, welding, adhesively attaching, rivets,
and wherein in particular the two parts (12, 13) are preconnected to each other preferably by one or several film hinges (16).

10. Exterior door handle according to claim 9,
characterized in that
the holder (10) can be brought into operational mechanical connection with the printed circuit board (30).

11. Exterior door handle according to claim 10,
characterized in that
the electrical conductors (21) of the Hall element (20) and/or the potential balancing element (40) are properly positioned on the printed circuit board (30) by the arrangement of the holder (10) at the printed circuit board (30).

12. Exterior door handle according to claim 1,
characterized in that
the electrical conductors (21) of the Hall element (20) and/or the potential balancing element (40) are soldered at the printed circuit board (30).

13. Exterior door handle according to claim 1,
characterized in that
the holder (10) and/or the Hall element (20) and/or the electrical conductors (21) of the Hall element (20) and/or the potential balancing element (40) exhibit positioning means (14) and/or prefixing means (41), which serve for the positioning and/or the prefixing at the printed circuit board (30).

14. Exterior door handle according to claim 13,
characterized in that
the holder (10) and/or the Hall element (20) and/or the electrical conductors (21) of the Hall element (20) and/or the potential balancing element (40) are disengageably connectable and make in particular a clip connection with the printed circuit board.

15. Exterior door handle according to claim 1,
characterized in that
the Hall element (20) and/or the electrical conductors (21) of the Hall element (20) and/or the potential balancing element (40) are disengageably or non disengageably connectable, in particular by getting jammed, making a clip connection, cramping, plugging, hooking behind, adhesively attaching, welding, injection molding, or casting.

16. Exterior door handle according to claim 1,
characterized in that
the Hall element (20) and/or its electrical conductors (21) and/or the potential balancing element (40) and/or the stamping grate frame (50) are at least in regions molded, wherein the molding forms the holder (10).

17. Method for the production of exterior door handles, in particular for vehicles,
characterized in that a standardized printed circuit board (30) is employed for different types of exterior door handles and wherein a Hall element (20) has to be disposed at different positions, and only a respective holder (10) in its form and size is adapted to the situation of the corresponding handle and of the desired position of the Hall element (20) for each type of exterior door handles.
